(19) United States
(12) Patent Application Publication
(10) Pub. No.: US 2002/0095386 A1
(43) Pub. Date: Jul. 18, 2002

(54) Account control and access management of sub-accounts from master account

(76) Inventors: L. Michael Maritzen, Fremont, CA (US); Kiyo Niwa-san, Haworth, NJ (US); Harold Aaron Ludtke, San Jose, CA (US); Yoshihiro Tsukamura, Kawasaki (JP)

Correspondence Address: Valley Oak Law, 5655 Silver Creek Valley Road, #106, San Jose, CA, 95138, US

(21) Appl. No.: 10/017,184

(22) Filed: Dec. 7, 2001

Related U.S. Application Data
(60) Provisional application No. 60/254,157, filed on Dec. 7, 2000.

(51) Int. Cl. G06F 17/60

(52) U.S. Cl. 705/64

(57) ABSTRACT

A system and method to manage and control access to content and transactions for use by a transaction device are described in detail below. In addition, authorization for an account to request content or conduct transactions may be confirmed locally within the transaction device. Further, setting levels of access and account management for each account can be performed locally within the transaction device. In one embodiment, access is requested from a secure entity. The access to the secure entity is granted if authentication information identifying a user requesting the access is provided to the secure entity. In one embodiment, a control parameter is stored on a local device; content is requested from the local device; and the content is locally compared with the control parameter on the local device to determine whether requesting the content is allowed. In another embodiment, a category is stored on a local device associated with an account; and the account is locally managed via the category on the local device. In yet another embodiment, a spending limit level is assigned to an account on a local transaction device; and transactions from the account on the local device are locally controlled in response to the spending limit level.

### CROSS REFERENCE TO RELATED APPLICATIONS

The present application claims benefit of U.S. Provisional Patent Application No. 60/254,157 filed on Dec. 7, 2000, entitled “Method and Apparatus for Agent-Enabled, PKI-Enabled Platform-Independent, Usage-Independent Consumer-Centric Account Control and Access Management of Sub-Accounts from a Master Account Involving a Biometric Device” listing the same inventors, the disclosure of which is hereby incorporated by reference.

### BACKGROUND OF THE INVENTION

Electronic commerce is achieving widespread use. Transactions are performed everyday over the Internet and through point of sale (POS) or bank systems. Such transactions are typically performed after the person requesting access to some information is authenticated and access is given to that person's private information, such as financial, medical, or other type of restricted records. Present systems are designed to maintain the integrity of the user's credit card, debit card, and account number. However, no measures are taken to ensure the secure authentication of the user in order to prevent unauthorized access by a potential thief.

Presently, applications providing access to sensitive information are based upon information that a potential thief may appropriate with relative ease. For example, some of the information presently required to grant access to sensitive material, such as a person's Social Security Number, date of birth, or mother maiden's name, is readily available. Once a potential thief collects any two pieces of this information, the thief may obtain access to the person's financial, medical, or other private information. In addition, most secure access systems are set up to divulge a person's entire file, once they receive the appropriate password and/or correct answers to the security questions. Therefore, a potential thief may steal the person's identity and ruin that person's credit.

Further, the current content screening mechanisms store user profiles on a remote device which weakens system security and does not allow the consumer to control content screening locally. Additionally, the current content screening mechanisms do not provide the master account and sub-account capabilities. The current content screening mechanisms also do not maintain system privacy during on-line transactions.

Additionally, each merchant typically has its own stand-alone DRM, causing the consumer to have to enter purchase information (i.e., credit card information, name, billing address, etc.) multiple times, even at a single merchant portal, in order to purchase multiple items.

### SUMMARY OF THE INVENTION

A system and method to manage and control access to content and transactions for use by a transaction device are described in detail below. In addition, authorization for an account to request content or conduct transactions may be confirmed locally within the transaction device. Further, setting levels of access and account management for each account can be performed locally within the transaction device. In one embodiment, access is requested from a secure entity. The access to the secure entity is granted if authentication information identifying a user requesting the access is provided to the secure entity.

In one embodiment, a control parameter is stored on a local device; content is requested from the local device; and the content is locally compared with the control parameter on the local device to determine whether requesting the content is allowed. In another embodiment, a category is stored on a local device associated with an account; and the account is locally managed via the category on the local device. In yet another embodiment, a spending limit level is assigned to an account on a local transaction device; and transactions from the account on the local device are locally controlled in response to the spending limit level.

### BRIEF DESCRIPTION OF THE DRAWINGS

The present invention is illustrated by way of example and not limitation in the figures of the accompanying drawings, in which like references indicate similar elements and in which:

FIG. 1 is a simplified block diagram of one embodiment of a secure transaction system.

FIG. 2 is a simplified block diagram of one embodiment of a privacy card for a personal transaction device.

FIG. 3 is a simplified block diagram of one embodiment of a digital wallet for a personal transaction device.

FIG. 4 is a simplified block diagram of one embodiment of a secure transaction system showing a point-of-sale terminal.

FIG. 5 is a simplified block diagram of one embodiment of a transaction privacy clearing house.

FIG. 6A illustrates one embodiment a structured access control system.

FIG. 6B illustrates one embodiment of a structured account management system.

FIG. 6C illustrates one embodiment of an exemplary account set up.

FIG. 7 illustrates one embodiment of a process for changing access controls and account management.

FIG. 8 illustrates one embodiment of a process for performing a transaction with embedded content.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well-known electrical structures or circuits are shown in block diagram form in order not to obscure the present invention unnecessarily.

A system and method to manage and control access to content and transactions for use by a transaction device are described in detail below. In addition, authorization for an account to request content or conduct transactions may be confirmed locally within the transaction device. Further, setting levels of access and account management for each account can be performed locally within the transaction device. In one embodiment, access is requested from a secure entity. The access to the secure entity is granted if authentication information identifying a user requesting the access is provided to the secure entity.

Security of the user's identity may be achieved in a variety of ways. In one embodiment, a single trusted location. For example, a transaction privacy clearing house (TPCH) contains user data. The user interfaces with the TPCH using the user's transaction device. The user therefore does not fill out online the electronic purchase forms at every product vendor's website. The TPCH acts as a financial transaction middleman, stripping off user identity information from transactions. As a result, the user's private information is not stored in several databases across the Internet and in private business networks. The secure locations where the financial data is stored minimizes the possibilities that hackers can access the data or accidental releases of the data can occur.

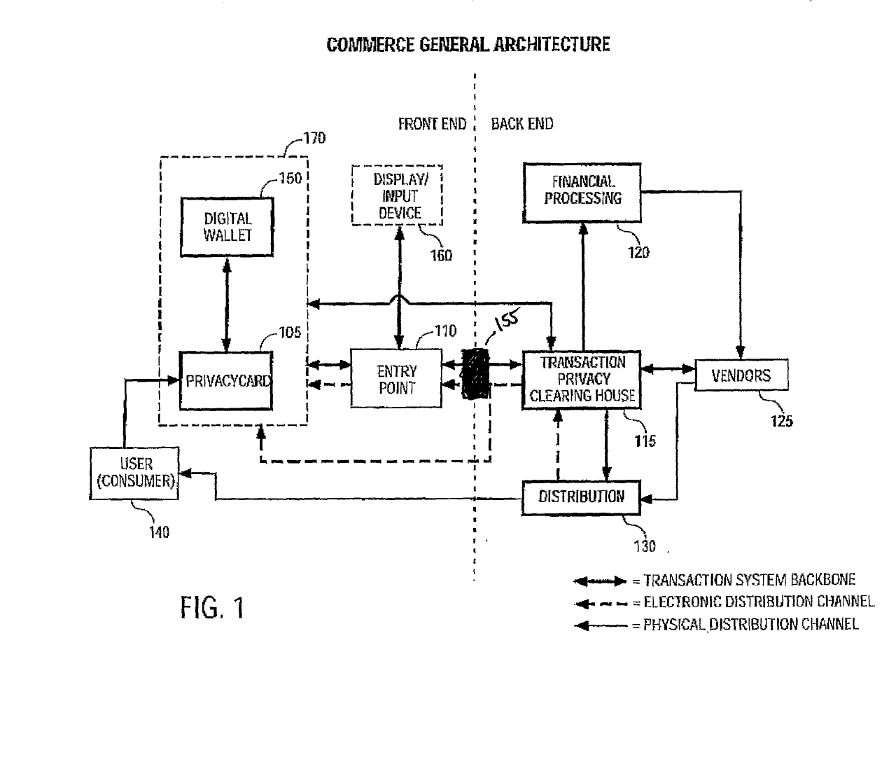

FIG. 1 is a simplified block diagram of one embodiment of a secure transaction system, which may be used in electronic commerce. As illustrated in FIG. 1, in this embodiment, a transaction privacy clearing house (TPCH) 115 interfaces a user (consumer) 140 and a vendor 125.

In this particular embodiment, a personal transaction device (PTD) 170, e.g., a privacy card 105, or a privacy card 105 coupled to a digital wallet 150, is used to maintain the privacy of the user while enabling the user to perform transactions. The personal transaction device 170 may include a privacy card, a digital wallet, a point of sale terminal, a laptop, a PDA, or any other device under the control of the user 140.

The personal transaction device 170 provides an interface for the user to exchange information. This exchange of information may include but is not limited to the user 140 receiving audio and/or visual content, instructions, requests, and the like from the personal transaction device 170. Further, this exchange of information may also include but is not limited to the personal transaction device 170 receiving instructions, payment authorization, authentication, and the like from the authorized user 140. In addition, the personal transaction device 170 may also contain wireless data communication, data storage and communication protocols for selectively communicating with outside devices such as a digital wallet described herein, point-of-sale terminal, or personal computer, and digital televisions.

In one embodiment, the personal transaction device 170 is configured to manage and control access to content and/or transactions received by individual accounts associated with the users of the personal transaction device.

In an alternate embodiment, account management and control of access to content is achieved through the PTD 170. The PTD 170 may assign particular accounts with varying levels of content access and may place accounts into convenient groupings for account management. The different levels of access to content are described below. The different categories that aid in account management are also described below.

The PTD 170 may be any suitable device that allows unrestricted access to TPCH 115. In one embodiment, the personal transaction device 170 may include a full screen that covers one side of the card. Alternately, in one embodiment in which the personal transaction device 170 is one embodiment of a privacy card, the privacy card may be coupled to device such as a digital wallet described herein, that provides a display. In one embodiment, the screen may be touch sensitive and be used for data input as well as output. In one embodiment, a user authentication mechanisms such as a fingerprint recognition for other mechanism may be built directly into the card. Furthermore, the privacy card may have a wireless communication mechanism for input and output.

A variety of user interfaces may be used. In one embodiment, and input device may be incorporated on the transaction device. Alternately or supplemental and input device may be coupled to the transaction device. In one embodiment, and input device may be provided on a digital wallet coupled to a privacy card. User inputs may be provided on the point-of-sale terminals including a personal point-of-sale terminal.

The personal transaction device information is provided to the TPCH 115 that then indicates to the vendor 125 and the user 140 approval of the transaction to be performed. The transaction device utilizes an identification to maintain confidentiality of the user's identity by applying the transaction device identification and the identity of the entity performing the transaction. Thus, all transactions, from the vendor's perspective, are performed with the transaction device.

In order to maintain confidentiality of the identity of the user 140, the transaction device information does not provide user identification information. Thus, the vendor 125 or other entities do not have user information but rather transaction device information. The TPCH 115 maintains a secure database of transaction device information and user information. In one embodiment, the TPCH 115 interfaces to at least one financial processing system 120 to perform associated financial transactions, such as confirming sufficient funds to perform the transaction, and transfers to the vendor 125 the fees required to complete the transaction. In addition, the TPCH 115 may also provide information through a distribution system 130 that, in one embodiment, can provide a purchased product to the user 140, again without the vendor 125 knowing the identification of the user 140. In an alternate embodiment, the financial processing system 120 need not be a separate entity but may be incorporated with other functionality. For example, in one embodiment, the financial processing system 120 may be combined with the TPCH 115 functionality.

In one embodiment, the financial processing system (FP) 120 performs tasks of transferring funds between the user's account and the vendor's account for each transaction. In one embodiment, the presence of the TPCH 115 means that no details of the transactions, other than the amount of the transactions and other basic information, are known to the FP 120. The TPCH 115 issues transaction authorizations to the FP 120 function on an anonymous basis on behalf of the user over a highly secure channel. The FP 120 does not need to have many electronic channels receiving requests for fund transfer, as in a traditional financial processing system. In one embodiment, a highly secure channel is set up between the TPCH 115 and the FP 120; thus, the FP 120 is less vulnerable to spoofing.

In one embodiment, the TPCH 115 contacts the FP 120 and requests a generic credit approval of a particular account. Thus, the FP 120 receives a minimal amount of information. In one embodiment, the transaction information, including the identification of goods being purchased with the credit need not be passed to the FP 120. In addition to conventional charge accounts, credit may include debit type, prepaid type, and the like. The TPCH 115 can request the credit using a dummy account ID that can be listed in the monthly credit statement sent to the user, so that the user can reconcile his credit statement. Further, the personal transaction device 105 can include functionality to cause the credit statement to convert the dummy account ID back to the transactional information so that the credit statement appears to be a conventional statement that lists the goods that were purchased and the associated amount charged.

A display input device 160 (shown in phantom) may be included to enable the user, or in some embodiments the vendor 125, to display status and provide input regarding the PTD 105 and the status of the transaction to be performed.

In yet another embodiment, an entry point 110 interfaces with the personal transaction device 170 and also communicates with the TPCH 115. The entry point 110 may be an existing (referred to herein as a legacy POS terminal) or a newly configured point of sale (POS) terminal located in a retail environment. The user 140 uses the PTD 170 to interface to the POS terminal in a manner similar to how credit cards and debit cards interface with POS terminals. The entry point 110 may also be a public kiosk, a personal computer, or the like.

In another embodiment, the PTD 170 interfaces through a variety of interfaces including wireless interfaces such as BlueTooth and infrared transmission; contactless transmission such as FeliCa and AmexBlue; and plug-in port transmission such as USB and RS-232C. A stand-in processor 155 (STIP) can interface with the PTD 170 in the event that the connection between the front end and the back end is disrupted for any reason. This way, the PTD 170 can gain authorization for a specified floor limit without necessarily receiving authorization from the back end. Further, this limits the amount of authorization thus minimizing fraud and insufficient funds.

The system described herein also provides a distribution functionality 130 whereby products purchased via the system are distributed. In one embodiment, the distribution function 130 is integrated with the TPCH 115 functionality. In an alternate embodiment, the distribution function 130 may be handled by a third party. Utilizing either approach, the system ensures user privacy and data security. The distribution function 130 interacts with the user through PTD 130 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 170 to change the shipping address of the product at any time during the distribution cycle.

A user connects to and performs transactions with a secure transaction system (such as shown in FIG. 1) through a personal transaction device (PTD) that has a unique identifier (ID). In one embodiment, a privacy card is used. In an alternate embodiment a digital wallet is used. In yet another alternate embodiment, a privacy card in conjunction with a digital wallet are used.

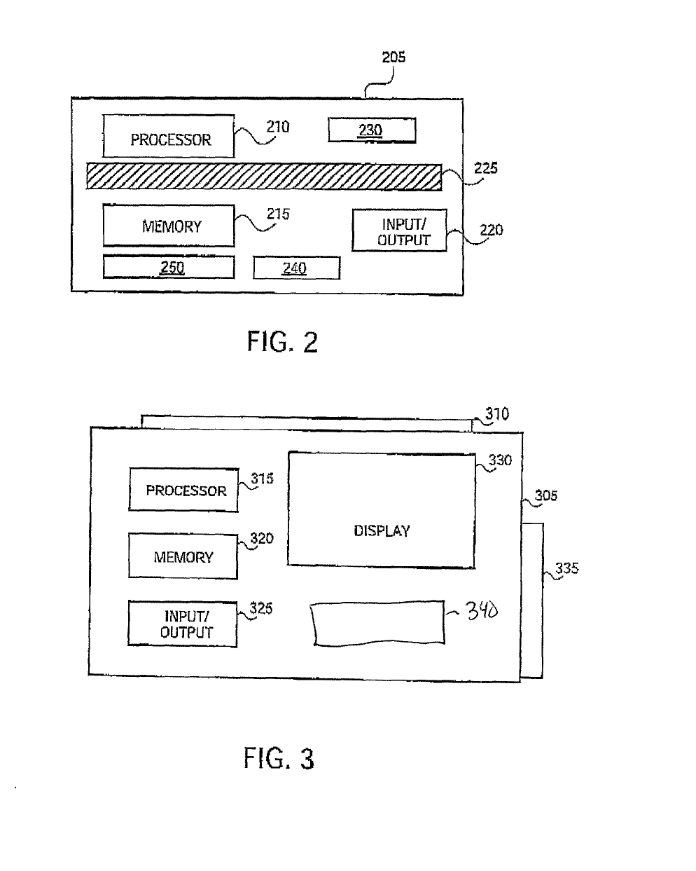

FIG. 2 is a simplified block diagram of one embodiment of a privacy card 205 for a personal transaction device. As illustrated in FIG. 2, in one embodiment, the card 205 is configured to be the size of a credit card. The privacy card includes a processor 210, memory 215 and input/output logic 220. The processor 210 is configured to execute instructions to perform the functionality herein. The instructions may be stored in the memory 215. The memory is also configured to store data, such as transaction data and the like. In one embodiment, the memory 215 stores the transaction ID used to perform transactions in accordance with the teachings of the present invention. Alternately, the processor may be replaced with specially configured logic to perform the functions described here.

The input/output logic 220 is configured to enable the privacy card 205 to send and receive information. In one embodiment, the input/output logic 220 is configured to communicate through a wired or contact connection. In another embodiment, the logic 220 is configured to communicate through a wireless or contactless connection. A variety of communication technologies may be used.

In one embodiment, a display 225 is used to generate bar codes scanable by coupled devices and used to perform processes as described herein. The privacy card 205 may also include a magnetic stripe generator 240 to simulate a magnetic stripe readable by devices such as legacy POS terminals.

In one embodiment, biometric information, such as fingerprint recognition, is used as a security mechanism that limits access to the card 205 to authorized users. A fingerprint touch pad and associated logic 230 is therefore included in one embodiment to perform these functions. Alternately, security may be achieved using a smart card chip interface 250, which uses known smart card technology to perform the function.

Memory 215 can have transaction history storage area. The transaction history storage area stores transaction records (electronic receipts) that are received from POS terminals. The ways for the data to be input to the card include wireless and contactless communications and the smart card chip interface which functions similar to existing smart card interfaces. Both of these approaches presume that the POS terminal is equipped with the corresponding interface and can therefore transmit the data to the card.

Memory 215 can also have user identity/account information block. The user identity/account information block stores data about the user and accounts that are accessed by the card. The type of data stored includes the meta account information used to identify the account to be used.

In another embodiment, the memory 215 also stores the account management information such as categories and the account access levels of content.

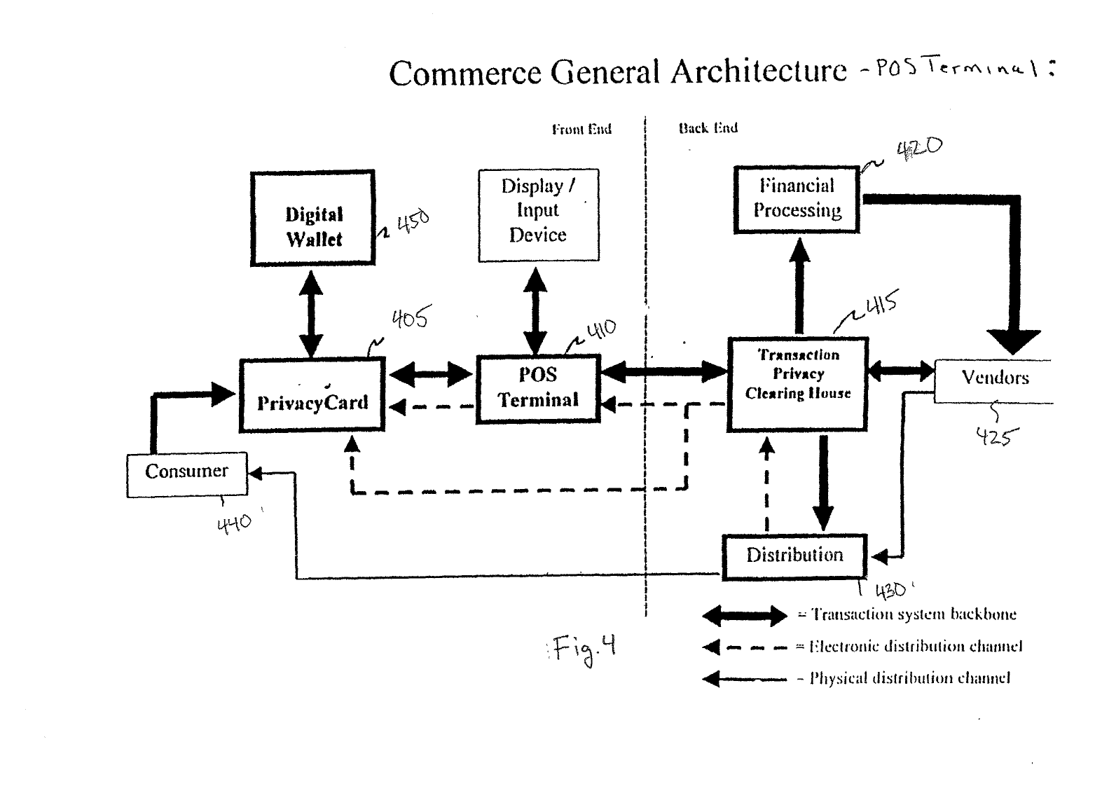

FIG. 3 is a simplified block diagram of one embodiment of a digital wallet 305 for a personal transaction device. As illustrated in FIG. 3, the digital wallet 305 includes a coupling input 310 for the privacy card 205, processor 315, memory 320, input/output logic 225, display 330, peripheral port 335, and account management module 340. The processor 315 is configured to execute instructions, such as those stored in memory 320, to perform the functionality described herein. Memory 320 may also store data including financial information, eCoupons, shopping lists, embedded content, and the like. The digital wallet may be configured to have additional storage. In one embodiment, the additional storage is in a form of a card that couples to the device through peripheral port 310.

In one embodiment, the account management module 340 stores account management information and access control data related to each individual account on the memory 320. The account management information is exemplified as classifying accounts into different categories as described below. Access control data is exemplified as classifying accounts into different level status as described below.

In one embodiment, the privacy card 205 couples to the digital wallet 305 through port 310; however, the privacy card 205 may also couple to the digital wallet 305 through another form of connection including a wireless connection.

Input/output logic 325 provides the mechanism for the digital wallet 305 to communicate information. In one embodiment, the input/output logic 325 provides data to a point-of-sale terminal or to the privacy card 205 in a pre-specified format. The data may be output through a wired or wireless connection.

The digital wallet 305 may also include a display 330 for display of status information to the user. The display 330 may also provide requests for input and may be a touch sensitive display, enabling the user to provide the input through the display.

The physical manifestation of many of the technologies in the digital wallet 305 will likely be different from those in the privacy card 205, mainly because of the availability of physical real estate in which to package technology. Examples of different physical representations would include the display, fingerprint recognition unit, etc.

The transaction device enhances security by authenticating the user of the card prior to usage such that if a card is lost or stolen, it is useless in hands and in an unauthorized person. One means of authentication is some type of PIN code entry. Alternatively, authentication may be achieved by using more sophisticated technologies such as a biometric solution. This biometric solution can include fingerprint recognition, voice recognition, iris recognition, and the like. In addition, in one embodiment in which multiple transaction devices are used, it may be desirable to configure the first device to enable and program the second device in a secure manner. Thus, the means of communication between the first device in the second device may include mutual device verification said that can unauthorized first device may not be used to enable a particular second device that does not belong to the same or authorized user.

In one embodiment, the transaction device, point of sale terminals and/or TPCH may function to verify the authenticity of each other. For example the transaction device may be configured to verify the legitimacy of the point-of-sale terminal and/or TPCH. A variety of verification techniques may be used. For example, listen device with account and/or access issues may be maintained. For example, in one embodiment, the public key infrastructure may be used to verify the legitimacy of the user.

Communication protocols include those that allow the digital wallet to specify which of several possible data structures to use for a transaction and communication protocols that allow the digital wallet and other devices to securely share data with the transaction device. The transaction device may represent a single account such as a particular credit card, or it may represent multiple accounts such as a credit card, telephone card, and debit card.

In one embodiment, the transaction device is intended to be the means by which the user interfaces with the invention. In one embodiment, the transaction device stores e-commerce related data on behalf of the user including transaction histories, meta account information needed to carry out a transaction using the transaction privacy clearinghouse function of the system, and various content. In one embodiment, the meta account information may be an extraction of the user's real identity as opposed to the actual user's name, address, etc. For example, the TPCH keeps records of the user's real bank account numbers, but assigned a different number for use by retailers and point-of-sale terminals. For example, and actual Bank Account No. may be 1234 0000 9876 1423 could be represented as 9999 9999 9999 9999. This number, in association with the transaction card's identification, could enable the TPCH to know that the bank account No. 1234 0000 9876 1423 was actually the account being used.

The purpose of this data is to abstract the user's identity while at the same time providing the necessary information for the transaction to be completed.

In one embodiment, the personalization process of the transaction device may be as described below. In this example, the transaction device is a digital wallet. The user turns on the transaction device. This can be accomplished by touching the finger print recognition pad or simply turning a switch. The transaction device performs at start a procedure, and attacks that it has not yet been personalized. Thus, it first prompt the user to enter the secret pin code. If the pin code entry fails, the user is prompted again. Ideally the user is given a finite number of chances to enter the data. After the last failure, the device may permanently disabled itself and thus becomes useless. It may also display in message requesting that the transaction device be returned to an authorized facility.

Assuming a successful pin code entry, the user may then be prompted to enter several of the security questions ever entered into the transaction device at processing center. Some of these questions might require data entry, and others might be constructed as simple multiple-choice, with both the correct as well as incorrect answers supplied. Assuming successful response to these questions, the user may then be prompted to enter secure personal identification information such as fingerprint data. In one embodiment, in which the fingerprint data is used, the user is prompted to enter fingerprint data by successively pressing one or more fingers against the recognition pad. The device prompt the user for each fingerprint that must be entered, for example, using a graphical image of a hand with the indicated finger.

The fingerprint data entry process may be performed at least twice to confirm that the user has entered the correct data. If confirmation succeeds, the device writes the fingerprint image data into their right once memory, or other memory that is protected from accidental modification. If confirmation fails, the user is prompted to start over with entry. Failure to reliably enter the fingerprint data after a finite number of tries will result in the device permanently disabled itself, and optional he providing an on-screen message to the user to go to secure processing facility such as a bank to complete the process. After successful personalization, the device is then ready to be used for the initial set of services that the user requested during the registration process. Once the device has been initialized for secure transactions, additional services could be downloaded to the device.

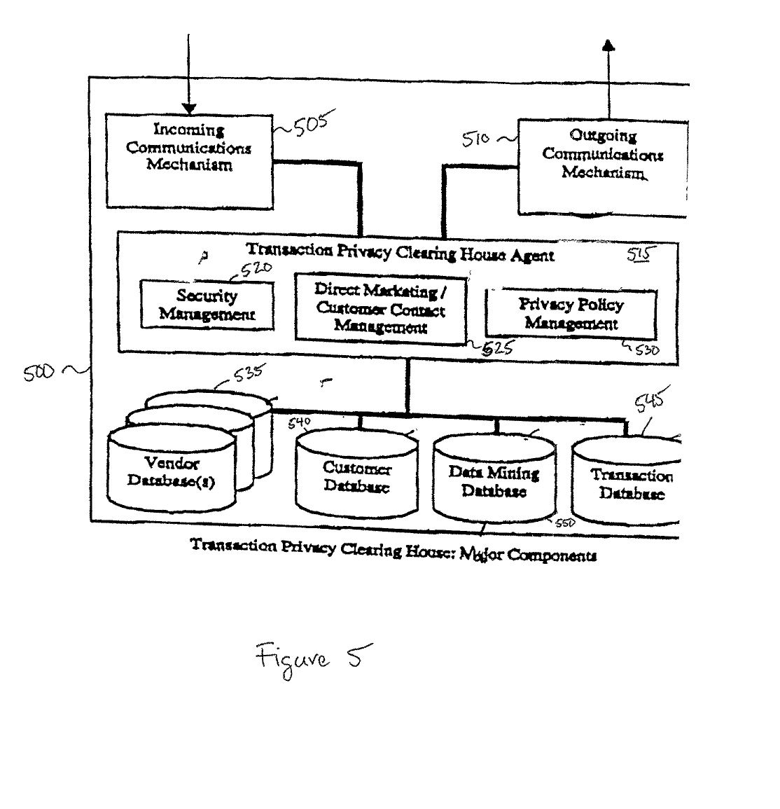

One embodiment of the system that utilizes a point-of-sale terminal is shown in FIG. 4. In this embodiment, the privacy card 405 interfaces with the point-of-sale terminal 410 and that point of sale terminal 410 communicates with that TPCH 415. That TPCH 415 interfaces with the financial processing system 420, the vendor 425 and the distribution system 430. The point-of-sale terminal may be an existing or newly configured point-of-sale terminal located in a retail environment. The user 440 uses the privacy card 405 to interface to the point-of-sale terminal a manner similar to how credit cards and debit cards interface with point-of-sale terminals. Alternately, a digital wallet 450 may be used by itself or with the privacy card 405 to interface to the point-of-sale terminal 410. Alternately, a memory device may be utilized solely as the interface with that point-of-sale terminal 410.

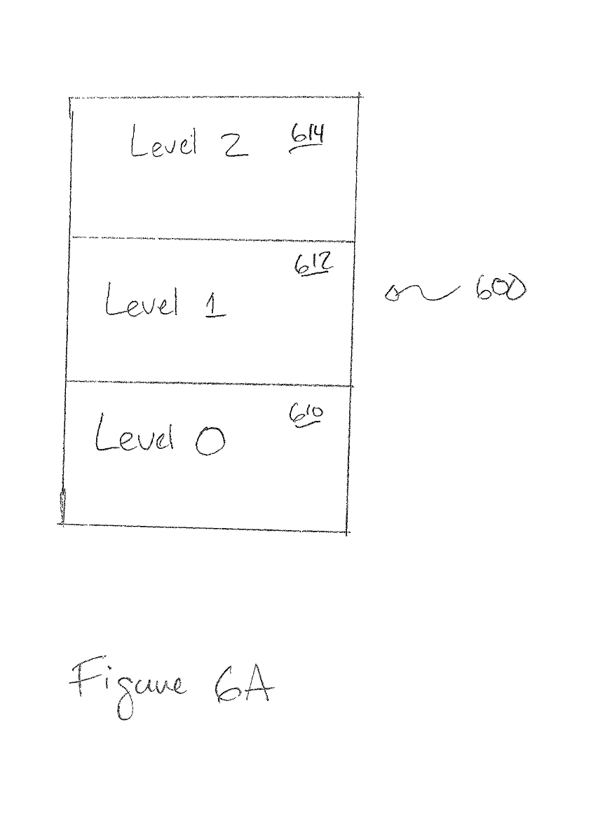

One embodiment of the TPCH is illustrated in FIG. 5. In one embodiment, the TPCH 500 is located at a secure location and is accessible to the transaction device. The TPCH 500 functions to provide the user with authorization to perform transactions without compromising the user's identity. The TPCH 500 may be embodied as a secure server connected to the transaction device in some form of direct connection or alternately a format in direct connection over the Internet or point-of-sale network.

Incoming communications mechanism 505 and outgoing communications mechanism 510 are the means of communicating with external retailers and vendors, as well as the transaction device such as the digital wallet. A variety of communication devices may be used, such as the Internet, direct dial-up modem connections, wireless, cellular signals, etc.

The TPCH agent 515 handles system management and policy control, informs their core functionality of the TPCH 500. In one embodiment, within the entire system, there is one clearinghouse agent, which resides permanently at the clearinghouse. Among the responsibilities handled by the agent include internal system management functions such as data mining, financial settlement and allocation of payments to internal and external accounts, embedded content management, and registration of new users joining the system.

The security management functions 520 ensure secure communications among the component internal to the TPCH 500 and the entities external to the TPCH 500. This function includes participating in secure communications protocols to open and maintain secure connections. This ensures that only authorized entities are allowed to access to data and that only authorized transaction devices can execute transactions against a user's account.

The TPCH agent 515 also provides a direct marketing and customer contact service 525, which in one embodiment is a data access control mechanism and maintain separate, secure access between various client and their databases. The data access control mechanism ensures that vendors have access only to the appropriate data in order to carry out the tasks of the system. One of the key features at the TPCH 500, the ability to carry out focused direct marketing while maintaining the privacy and identity protection of consumer, is handled by this mechanism.

The TPCH agent 515 can be configured to actively looking for content on behalf of the user as well as filter out unwanted incoming information. In one embodiment, the data may be described by XML and the agent may operate via Java applets.

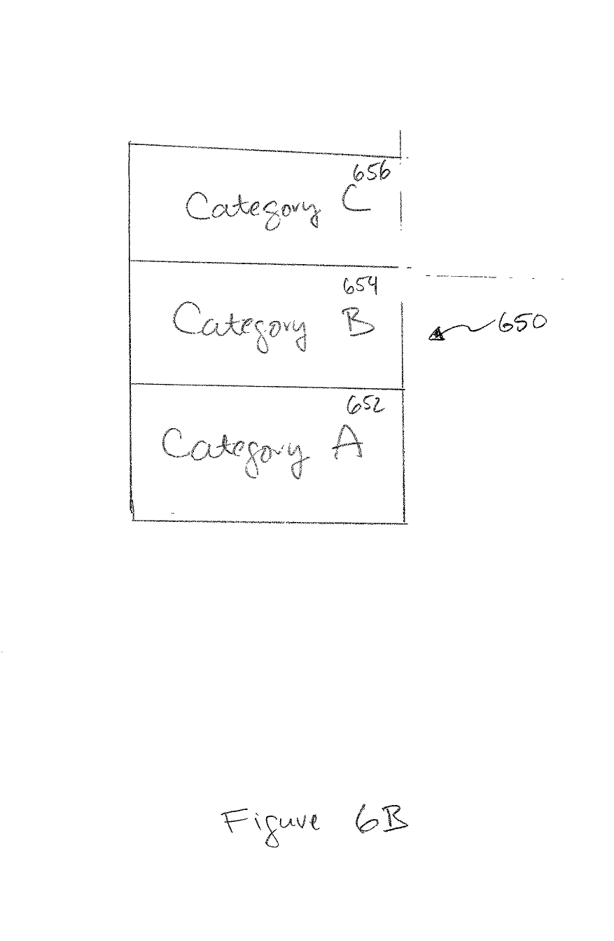

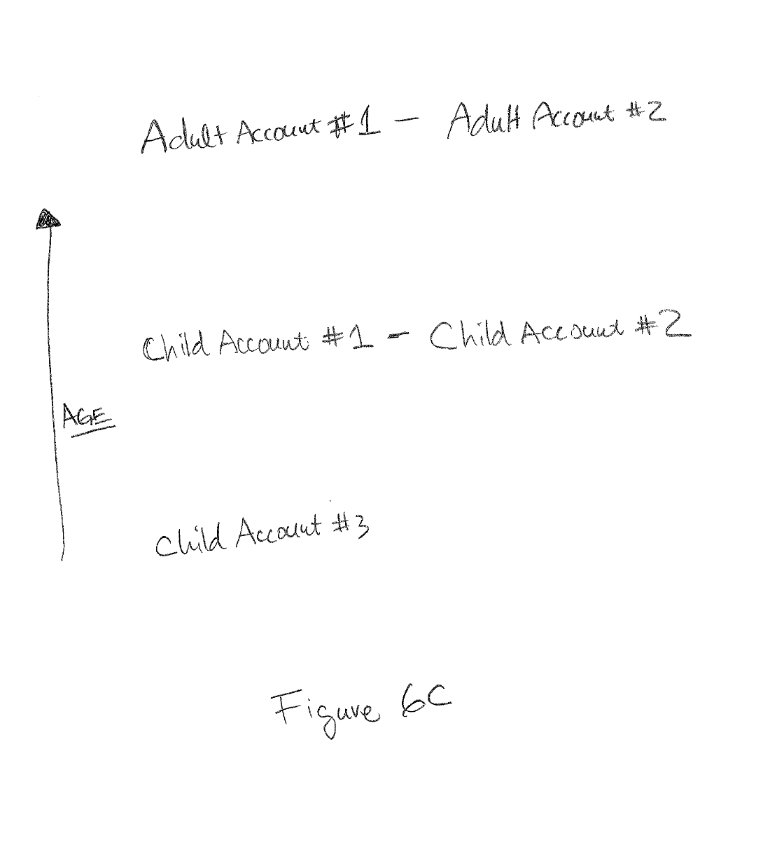

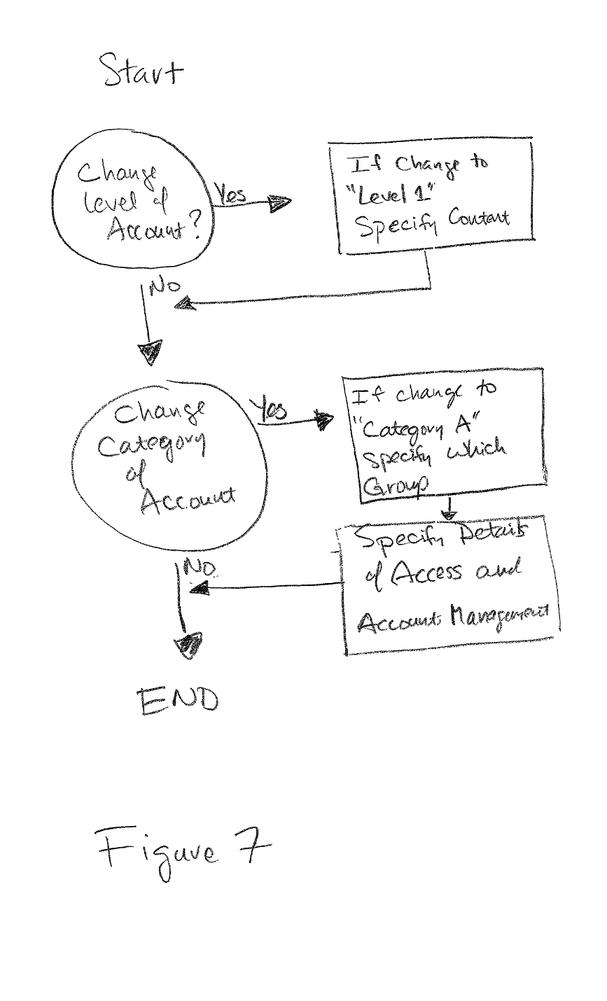

FIG. 6A illustrates different levels of access which can be created for each account within the transaction device by the account management module 340 (FIG. 3). In one embodiment, the varying types of access granted for each account is reflected in table 600 as a multi-level structure. In one embodiment, this multi-level structure is defined and created from the master account. In one embodiment, each account is assigned a particular level of access status.

In one embodiment, Level 0 (610) status is the most restricted level of access. For example, an account having Level 0 (610) status would have no access rights to adult content, products, services or functions. In one embodiment, Level 1 (612) has a moderately restricted level of access. For example, an account having Level 1 (612) status would have some access rights to adult content, products, services or functions. In one embodiment, Level 1 (612) status would entitle the account user to access material having an “R” movie rating but would exclude all “X” rated material. In one embodiment, Level 2 (614) has an unrestricted level of access. For example, an account having Level 2 (614) status would have access rights to any content, products, services or functions.

In another embodiment, there may be greater or fewer number of access levels. In yet another embodiment, there may be different criteria in defining the boundaries for each access level.

Various accounts are displayed in FIG. 6C for illustrative purposes. These accounts and associated individuals displayed within FIG. 6C and described below are shown to merely demonstrate the different access levels as described above. In one embodiment, the adult individuals associated with adult account #1 and adult account #2 are spouses. Further, children associated with child account #1 and child account #2 are both 16 years old. The child associated with child account #3 is 8 years old. In this example, adult account #1 and adult account #2 are considered the master accounts. Further, child account #1, child account #2, and child account #3 are considered sub-accounts to the master accounts (in this case, adult account #1 and adult account #2.)

For exemplary purposes, child account #1 has the Level 0 status. Then, child account #1 would be denied access to providers, merchants, web sites which contain and/or provide “adult” products, services, and/or functions.

For exemplary purposes, child account #1 has the Level 1 status. Then, the master account (either adult account #1 or adult account #2) may selectively identify which providers, merchants, and/or web sites are not allowed to be accessed by the child account #1 In another embodiment, the master account may identify which product or service types from providers, merchants, and/or web sites that are not allowed to be accessed by child account #1.

For exemplary purposes, adult account #1 has the Level 2 status. The adult account #1 has unrestricted access to any material which may include “X” rated and “R” rated materials.

FIG. 6B illustrates different category levels of control which can be assigned to each account within the transaction device by the account management module 340 (FIG. 3). The different category levels that can be assigned to each account create groups of accounts which can be managed and administered in a similar manner. By creating these groups of accounts, basic customizable rules can be applied to all accounts within that group. In one embodiment, the varying levels of control in managing each account is reflected in table 650 as a multi-level structure. In one embodiment, this multi-level structure is defined and created from the master account. In one embodiment, each account can be assigned a particular control category to aide in administration and management of the accounts within the transaction device. In one embodiment, the master account is authorized to assign a particular category to an account.

In one embodiment, each account with Category A (652) designation has the same level of access controls and account management. The Category A (652) designation offers the least amount of local control for each account and is not capable of individual account customization.

In one embodiment, each account with Category B (654) designation has it's own unique level of access control and account management. However, the Category B (654) designation does not allow the individual account user to set it's own access control and account management. The Category B (654) designation also does not permit the individual account user to set access control and control management of other accounts.

In one embodiment, each account within the Category C (656) designation can set access controls and account management for other accounts.

Taking for exemplary purposes the Category A designation, the children associated with child account #1 and child account #2 could have the same access control and account management under the Category A designation. In this example, since the children associated with child account #1 and child account #2 are the same age (16 years old), they may also have the same content viewing restrictions such no “X” rated content and limited “R” rated content with no nudity. They may also have the same account management restrictions such as an on-line spending limit of $10 per week. The children associated with child account #1 and child account #2 would not be allowed to change their own access restrictions or management restrictions. Further, they would also not be allowed to make these changes for other accounts either. Changes made to either child account #1 or child account #2 with respect to access restrictions or management restrictions would be applicable to both accounts. Under this scenario, the child account #1 and the child account #2 could both be under the same Category A designation.

Taking for example the Category B designation, the children associated with child account #1 (16 years old), child account #2 (16 years old), and child account #3 (8 years old) could have different access control and account management under the Category B designation. In this example, each child associated with child account #1, child account #2, and child account #3 have different needs with respect to access control and account management. For example, child #1 (associated with the child account #1) is more mature than child #2 (associated with the child account #2) and child #3 (associated with the child account #3.) Accordingly, child account #1 is granted access to “R” rated content. On the other hand, child account #2 is granted access to some “R” rated content, and child account #3 is granted access to “G” rated content. Further, both child account #1 and child account #2 are have the same account management restrictions such as an on-line spending limit of $10 per week. Child account #3 currently has no on-line spending privileges.

The children associated with child account #1, child account #2, and child account #3 would not be allowed to change their own access restrictions or management restrictions. Further, they would also not be allowed to make these changes for other accounts either. Changes made by adult account #1 or adult account #2 to either child account #1, child account #2, or child account #3 with respect to access restrictions or management restrictions would not be applicable to all accounts. Under this scenario, child account #1, child account #2, and child account #3 have different access restrictions and account management. Child account #1, child account #2, and child account #3 could be under the same Category B designation.

Taking for example the Category C designation, this would allow adult account #1 to designate the Category C designation for adult account #2. By designating the adult account #2 as Category C, the adult account #2 can set access controls and account management for other accounts such as child account #1, child account #2, or child account #3.

As another specific example, assume that user (Paul) has registered with the personal transaction device, using a PKI-enabled biometric device. The user creates a master account for himself, and has created sub-account #1 for his wife with Level 2 and Category C access controls and account management. His wife (Linda) then registers herself with the sub-account and creates 3 sub-accounts, as follows: Sub-account #2 is for son George who is 12 years of age. Sub-account #3 is for Ringo who is 17 years of age. Sub-account #4 is for the family nanny, Yoko. The wife sets up the access controls and account management for each sub-account as follows: Sub-account #2 has Level 0 and Category B; Sub-account #3 has Level 1 and Category B; Sub-account #4 has Level 2 and Category C. Sub-account #4 (the nanny) has the ability to maintain the merchants, service providers, and/or web sites for sub-accounts #2 (child George) and #3 (child Ringo). So in this specific example, George is not allowed to browse a book store web site at all, whereas Ringo is allowed to browse and purchase products from the book store web site, except for products and services that are restricted as indicated by the merchant's category code. Also, Ringo is in college, and his sub-account #3 receives a monthly allowance of $100 which can only be used to purchase grocery products (excluding liquor and tobacco related) from a grocery merchant.

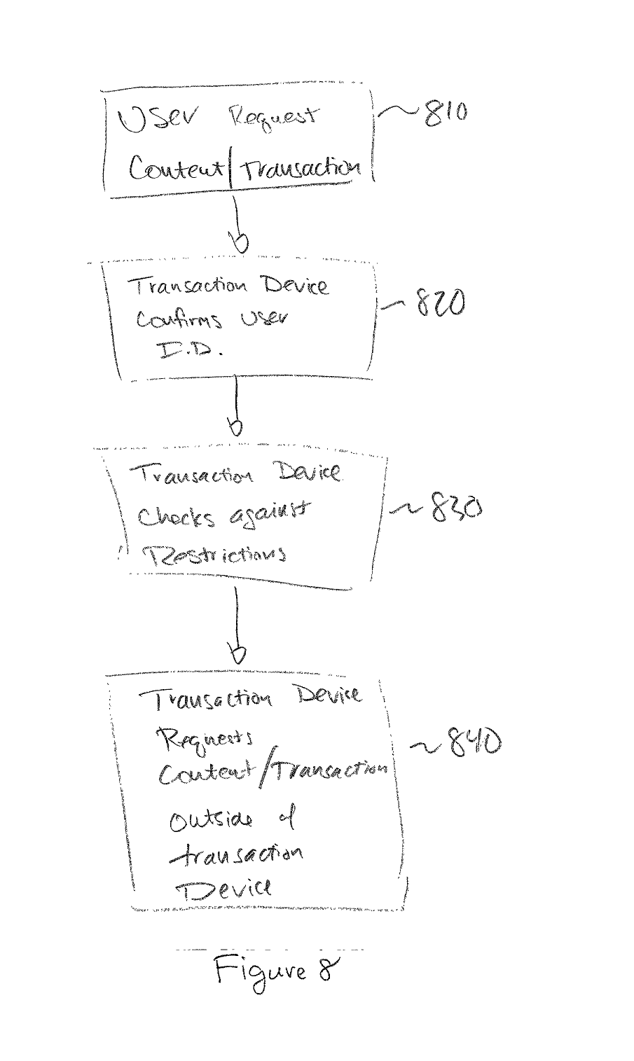

FIGS. 7 and 8 contain flow diagrams including functional blocks to merely provide examples of the invention. They illustrate specific embodiments of the invention. The following functional blocks may occur in different sequences. Further, additional or fewer the functional blocks may be utilized.

FIG. 7 illustrates a flow diagram describing a modification to an account. Block 700 allows the master account to change the Level status of any of the accounts. In one embodiment, if the master account changes the Level status of any of the accounts to Level 1, the master account is requested to provide specific content or a content type that is not allowed to be view and/or accessed by the user of this account as shown in Block 710. Block 720 allows the master account to change the Category status of any of the accounts. In one embodiment, if the master account changes the Category status of an account, the master account is requested to provide specific details regarding access control and account management as shown in Block 740. In Block 730, if an account is changed to Category A status, then the master account is requested to provide a specific group affiliation associated with this account.

FIG. 8 illustrates a flow diagram describing interaction between the user and the transaction device. In Block 810, a user requests content and/or a transaction from the transaction device. In Block 820, the transaction device confirms the identification of the user utilizing a PIN code and/or biometric authorization before proceeding. In Block 830, the transaction device checks the request for content and/or transaction with the restrictions associated with the user's account. Assuming that the requested content and/or transaction is allowable, the transaction device requests the content and/or transaction from an entity outside the transaction device as represented in Block 840, However, if the requested content and/or transaction is not allowable based on the restrictions associated with the user's account, the transaction device does not forward the request for the content and/or transaction.

The foregoing descriptions of specific embodiments of the invention have been presented for purposes of illustration and description.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A transaction device comprising:
a. an account management module for locally managing account functions; and
b. a storage device connected to the account management module for locally storing account data from the account management module.

2. The device according to claim 1 wherein the account management module grants and enforces access rights for viewing content.

3. The device according to claim 1 wherein the account management module grants and enforces spending rights.

4. The device according to claim 1 wherein the account management module enforces a set of rules for modification of an account parameter.

5. The device according to claim 4 wherein the set of rules includes a hierarchy of accounts and sub-accounts.

6. The device according to claim 4 wherein the account parameter includes a level of authorization for content.

7. The device according to claim 4 wherein the account parameter includes a spending level authorization.

8. The device according to claim 1 further comprising an authentication module connected to the account management module for locally authenticating an identity of a user of the transaction device.

9. The device according to claim 8 wherein the authentication module is a biometric device.

10. The device according to claim 9 wherein the biometric device relies on a fingerprint scan.

11. The device according to claim 8 wherein the biometric device relies on an iris scan.

12. The device according to claim 1 wherein the account data includes financial data.

13. The device according to claim 1 wherein the account data includes access rights data.

14. The device according to claim 1 further comprising a transaction privacy clearing house interface connected to the account management module configured to securely complete a financial transaction with a vendor anonymously.

15. A method comprising:
a. selecting a parameter to control access to content from a local device;
b. storing the parameter on the local device; and
c. comparing a content request to the parameter on the local device.

16. The method according to claim 15 wherein the parameter is a category designation.

17. The method according to claim 15 wherein the parameter is a level status.

18. The method according to claim 15 wherein the parameter is a spending limit.

19. The method according to claim 15 further comprising checking an identification of a user of the local device.

20. The method according to claim 15 further comprising requesting content associated with the content request from a remote device in response to comparing the content request.

21. The method according to claim 20 wherein the remote device is a web site.

22. The method according to claim 20 wherein the remote device is a transaction privacy clearing house.

23. A method comprising:
a. storing a control parameter on a local device;
b. requesting content from the local device; and
c. locally comparing the content and the control parameter on the local device to determine whether requesting the content is allowed.

24. The method according to claim 23 wherein the control parameter is a category designation.

25. The method according to claim 23 wherein the control parameter is a level status.

26. The method according to claim 23 wherein the control parameter is a spending limit.

27. The method according to claim 23 further comprising checking an identification of a user of the local device.

28. The method according to claim 23 further comprising requesting the content from a remote device in response to comparing the content request.

29. The method according to claim 28 wherein the remote device is a web site.

30. The method according to claim 28 wherein the remote device is a transaction privacy clearing house.

31. A method comprising:
a. storing a category on a local device associated with an account; and
b. locally managing the account via the category on the local device.

32. The method according to claim 31 wherein locally managing further comprises selecting a spending limit for the account.

33. The method according to claim 31 wherein locally managing further comprises selecting a content access control for the account.

34. The method according to claim 31 further comprising managing a plurality of accounts by selecting a single spending limit for the plurality of accounts.

35. The method according to claim 31 further comprising managing a plurality of accounts by selecting a single content access control for the plurality of accounts.

36. A method comprising:
a. assigning a content access level to an account on a local transaction device; and
b. locally controlling content accessibility to the account on the local device in response to the content access level.

37. A method comprising:
a. assigning a spending limit level to an account on a local transaction device; and
b. locally controlling transactions from the account on the local device in response to the spending limit level.

38. A computer-readable medium having computer executable instructions for performing a method comprising:
a. storing a control parameter on a local device;
b. requesting content from the local device; and
c. locally comparing the content and the control parameter on the local device to determine whether requesting the content is allowed.
